(19) United States
(12) Patent Application Publication
(10) Pub. No.: US 2026/0317461 A1
(43) Pub. Date: Oct. 15, 2026

(54) SINGLE REACTOR-MADE BIMODAL HIGH-DENSITY POLYETHYLENE COPOLYMER AND METHODS AND ARTICLES

(71) Applicant: Univation Technologies, LLC, Houston, TX (US)

(72) Inventors: Rujul M. Mehta, Manvel, TX (US); Cliff R. Mure, Hillsborough, NJ (US); Chuan C. He, Missouri City, TX (US); John F. Szul, Fayetteville, WV (US)

(21) Appl. No.: 19/481,944

(22) PCT Filed: Jun. 20, 2024
(86) PCT No.: PCT/US2024/034777

§ 371 Date: Nov. 6, 2025

Related U.S. Application Data
(60) Provisional application No. 63/522,729, filed on Jun. 23, 2023.

(51) Int. Cl. C08F 210/16; C08F 2/34; C08F 4/6592

(52) U.S. Cl. CPC C08F 210/16; C08F 2/34; C08F 4/65925

(57) ABSTRACT

A single reactor-made bimodal high-density polyethylene copolymer as described and claimed, a method of making the copolymer, a formulation comprising the copolymer and an antioxidant, a method of making a manufactured article from the copolymer or formulation; the manufactured article made thereby, and use of the manufactured article.

### FIELD

Polyethylene polymers, formulations, and related methods and manufactured articles.

### INTRODUCTION

Patents in or about the field include U.S. Pat. Nos. 7,193,017 B2; 8,318,872 B2; and 11,149,146 B2.

The term “polyethylene-raised temperature” or “PE-RT” is a category of high-density polyethylene resin that has performance properties suitable for tubing and pipe applications that are exposed to a harsh environment such as cold and/or hot temperatures, chemicals, mechanical stress, and/or pressure. Commercial uses of PE-RT tubing and pipes include plumbing (hot and cold potable water service and radiant heating/cooling systems in floors, walls, and ceilings), hydronic heating and cooling (radiators, fan coils), outdoor snow and ice melting, and ground source geothermal piping systems. Thus, the PE-RT tubing and pipes should have resistance to one or more of heat, cold, pressure, chemicals, and/or stress-induced cracking.

Within the PE-RT resin category, different uses have different performance requirements. For example, ASTM F2623 sets forth standard specifications for PE-RT SDR9 tubing. ASTM F2769 sets forth standard specifications for PE-RT plastic hot and water tubing and distribution systems. ASTM F2023 sets forth standard test method for evaluating oxidative resistance of crosslinked polyethylene tubing and systems to chlorinated hot water. AWWA C906 sets forth standards for waterworks pressure pipe and fittings for pipe diameters from 4 to 65 inches (100 to 1650 millimeters). CSA B127.18 sets forth standards for PE-RT tubing systems for pressure applications. ISO 22391 (2009) sets forth standards for PE-RT Type I pipes (flexible type) and PE-RT Type II pipes (rigid type).

Although the standards of ISO 22391 (2009) are challenging enough to meet, China has set forth additional performance requirements for PE-RT resins in GB/T 28799:2020. For example, ISO 22391 (2009) requires hydrostatic pipe strength tested according to ISO 9080 with a lower confidence limit of the predicted hydrostatic strength σ_{LPL} to be at least 9.33 megapascals (MPa) at 20° C. and 438,000 hours, 5.06 MPa at 70° C. and 438,000 hours, 3.23 MPa at 95° C. and 87,600 hours, and 2.33 MPa at 110° C. and 8,760 hours. Compare that to GB/T 28799:2020, which requires hydrostatic pipe strength tested with a lower confidence limit of the predicted hydrostatic strength σ_{LPL} to be at least 9.62 MPa at 20° C. and 438,000 hours, 5.31 MPa at 70° C. and 438,000 hours, 3.40 MPa at 95° C. and 87,600 hours, and 2.44 MPa at 110° C. and 8,760 hours.

The molecular architecture of a particular high-density polyethylene (HDPE) resin will determine whether or not the resin would satisfy a selected set of standard specifications. The molecular architecture comprises the composition of its polyethylene molecules (e.g., comonomer unit content and distribution of comonomer units across molecular weight range), type and amount of branching (short chain branching and long chain branching) of its polyethylene molecules, average molecular weights (i.e., Mₙ, M_{w}, and M_{z}) of its polyethylene molecules, the molecular weight polydispersity (or simply “polydispersity” or “PDI”) such as M_{w}/Mₙ or M_{z}/M_{w} of its polyethylene molecules or of the overall resin, and the extent of chain entanglement of its polyethylene molecules. Some of these molecular architecture features affect a resin's melt rheology and processability in melt extrusion manufacturing of tubing and pipe, whereas other molecular architecture features, such as branching, polydispersity, and chain entanglement, affect the manufactured tubing or pipe's ability to resist heat, cold, pressure, chemicals, and/or stress-induced cracking.

For an HDPE resin to be accepted as a PE-RT Type 11 resin by both pipe manufacturers and their customers that buy and use the pipe in harsh environments, the HDPE resin must have sufficient melt rheology and processability to enable economical pipe production outputs while the pipe must withstand those harsh environments for a sufficient operating lifetime. These requirements of melt rheology and processability and pipe resistance to heat, cold, pressure, chemicals, and/or stress-induced cracking compete with each other. Improving melt rheology and processability typically worsens pipe performance, and improving pipe resistance to heat, cold, pressure, chemicals, and/or stress-induced cracking typically worsens economical production output. For example, pipe manufacturers desire to operate their pipe extruders at line speeds producing 40 to 60 meters of pipe per second (m/sec). If the line speed is too low, such as 20 m/sec or 10 m/sec of pipe produced, the cost of the pipe becomes too high. If melt viscosity of the PE-RT Type II resin is decreased to increase extrusion of pipe at line speeds of 40 m/sec to 60 m/sec, then the hydrostatic strength of the resulting pipe may fall below standards desired by their customers that buy and use the pipe.

In the field of PE-RT Type II resins for rigid pipe applications, some HDPE resins may satisfy ISO 22391 (2009) requirements but are unable to satisfy GB/T 28799:2020 requirements. In some cases this inability is because the HDPE resin has a unimodal polydispersity index (PDI), M_{w}/Mₙ, which means there is one peak in the range of log(molecular weight) or “Log(MW)” from 3 to 6, i.e., the range of molecular weight from 1,000 to 1,000,000 grams per mole (g/mol), and a resulting narrow distribution of molecular weight.

In other cases, the prior HDPE resin has a bimodal PDI. A bimodal HDPE resin comprises a higher molecular weight (HMW) polyethylene component and a lower molecular weight (LMW) polyethylene component. But prior bimodal HDPE resins can have an inadequate molecular architecture for GB/T 28799:2020 due to the following manufacturing method (a) or (b) that is used to make it: (a) one of the polyethylene components of the bimodal resin is made first, and then the other component is made in the presence of the first component via a dual reactor polymerization process/dual reactor system; or (b) the two polyethylene components of the bimodal resin are made independently, and later they are melt blended together via a post-reactor processing method.

The deficiencies of the dual-reactor manufacturing method (a) and the dual reactor-made bimodal resins it makes arise from the limitations of the dual-reactor system, which comprises a first reactor that feeds into a second reactor in series, and the limitations of the dual-reactor polymerization process, which feeds active first resin product made in the first reactor directly into the second reactor. The second reactor makes a second resin product in the presence of the first resin product. For example, the first reactor may make the HMW polyethylene component, which is then fed directly into the second reactor, which then makes the LMW polyethylene component in situ in the presence of the HMW polyethylene component. The reverse sequence is also possible wherein the first reactor may make the LMW polyethylene component, which is then fed directly into the second reactor, which then makes the HMW polyethylene component in situ in the presence of the LMW polyethylene component. Either way the resulting bimodal PE-RT Type II resin product is then discharged from the second reactor. The dual-reactor process achieves the bimodal PDI of the bimodal resin by either (a) using different reactor types such as a gas phase polymerization reactor as the first reactor and a slurry phase polymerization reactor as the second reactor; or (b) using a different unimodal polymerization catalyst and the same or different polymerization conditions in the second reactor as in the first reactor; or (c) using the same unimodal polymerization catalyst, but different polymerization conditions in the second reactor as in the first reactor. The problem with dual-reactor processes/systems is that the particular monomer feeds, catalyst, polymerization conditions, and residence time used in the first reactor, must be compatible with the choices of monomer feeds, catalyst, polymerization conditions, and residence time used in the second reactor. For example, it would be problematic to make an ethylene/1-hexene copolymer as the HMW polyethylene component in the first reactor and a comonomer-free polyethylene homopolymer as the LMW polyethylene component in the second reactor because inevitably at least some unreacted 1-hexene from the first reactor will be transferred with the HMW polyethylene product into the second reactor, where it will then copolymerize.

Further, the nature of a dual-reactor system is that the intermixing of the HMW polyethylene component with the LMW polyethylene component occurs only in the second reactor and only after particles one of the components are already formed. The first polyethylene component (HMW or LMW as the case may be) is made in the first reactor using catalyst particles. The resulting first polyethylene component comprises polyethylene particles that can have large domains of the first polyethylene component and large voids. These polyethylene particles are transferred into the second reactor, which makes the second polyethylene component (the other one of the HMW or LMW). The second polyethylene component fills in the voids to give bimodal polyethylene particles that have large domains of each polyethylene component. This means that the mixing of HMW and LMW polyethylene components in the second reactor comprises forming different domains of the HMW polyethylene component and LMW polyethylene component on catalyst particles. These domains can be difficult to mix sufficiently well in the extruder without applying excessive energy that could cause polymer degradation. Another problem is that bimodal polyethylene particles having large domains of each HWM and LMW component can limit the components' molecular weight choices. If their molecular weights are too far apart, the LMW domains will have very low viscosity in the melt that will not impart enough shear stress on the HMW domains (particularly if they are very high in MW) to mix them together. The inventive bimodal catalyst system avoids these problems. These inherent deficiencies of the dual-reactor system/polymerization method (a) and dual reactor-made bimodal resins made thereby include, but may not be limited to, failure to enable sufficient chain entanglement of molecules of the two components, which in turn can limit the molecular architecture of the dual-reactor bimodal HDPE resin and prevent it from meeting all the standard specifications of GB/T 28799:2020.

The deficiencies of the individual reactor-made unimodal resin manufacturing method (b) and the post-reactor blended bimodal resins made, there arise from the limitations of the post-reactor melt-blending. If the bimodal resin's HMW and LMW polyethylene components are made as separate products independently from each other, they then must be melt-blended together in a post-reactor device (e.g., an extruder) to make the bimodal resin. Although this post-reactor blending process avoids the problems/limitations associated with the manufacturing method (a) dual-reactor system/process, such as the problems of incompatible monomer feeds, catalysts, polymerization conditions, and residence times, it can create other molecular architecture deficiencies. For example, melt blending alone may be insufficient for achieving sufficient chain entanglement of the separately made HMW and LMW polyethylene components because the melt mixing times in an extruder are very short, i.e., less than 60 seconds. If the melt mixing times would be lengthened to increase chain entanglement, the resulting increased exposure to high temperatures could generate structural defects, such as gels, in the post-reactor melt blended bimodal resin. Either molecular architecture problem can cause failure to meet the standard specifications of GB/T 28799:2020.

In summary it is very challenging to design a high-density polyethylene resin for PE-RT Type II (rigid) pipes that can satisfy the standard specifications of ISO 22391 (2009), and even more challenging to design an HDPE resin that can satisfy the standard specifications of GB/T 28799:2020.

### SUMMARY

We disclose an improved high-density polyethylene (HDPE) resin. The inventive HDPE resin has a molecular architecture that has been discovered to satisfy the standard specifications of ISO 22391 (2009), the standard specifications of GB/T 28799:2020, or both. The inventive HDPE resin is thus particularly useful for making rigid pipes, but it's uses are not limited to pipes.

The inventive HDPE resin is detailed later. The inventive HDPE resin is made in a single reactor and comprises a higher molecular weight (HMW) polyethylene component and a lower molecular weight (LMW) polyethylene component and has a bimodal polydispersity index (PDI). The inventive “single reactor-made” feature of the HDPE resin means that both the HMW and LMW polyethylene components are made in situ in the same gas phase polymerization reactor at the same time under the same process conditions using the same bimodal catalyst system. Thus, the inventive HDPE resin is not made in a dual reactor or by a dual reactor process and the HMW and LMW components are not made in separate processes, and melt-blended later in a post-reactor melt-blending process. In fact it is doubtful that the exact HMW and LMW components of the inventive HDPE resin could be made in a dual reactor process or in separate processes followed by post-reactor blending.

Our choices of bimodal catalyst system and gas phase polymerization method in combination with our discovery of suitable gas phase polymerization conditions have surprisingly resulted in an inventive single reactor-made HDPE resin having sufficient molecular architecture for achieving satisfactory melt rheology and processability of the resin in its melt (liquid) state in combination with sufficient chain entanglement of the polyethylene molecules of the HDPE resin in its solid state, including sold state in the form of a PE-RT Type II pipe.

We also disclose related inventive embodiments, including, but not limited to:

A single-reactor method of making the single reactor-made bimodal high-density polyethylene copolymer, the method comprising gas phase polymerization of ethylene and the 1-alkene in a single gas phase polymerization reactor, as described herein.

A formulation comprising the single reactor-made bimodal high-density polyethylene copolymer and an additive.

A method of making a manufactured article from the single reactor-made bimodal high-density polyethylene copolymer or the formulation.

A manufactured article comprising the single reactor-made bimodal high-density polyethylene copolymer or the formulation.

A method of making the manufactured article.

### DETAILED DESCRIPTION

The single reactor-made bimodal high-density polyethylene copolymer, also referred to herein as a “single reactor-made bimodal HDPE copolymer”, is a composition of matter.

The single reactor-made bimodal HDPE copolymer comprises a higher molecular weight poly(ethylene-co-1-alkene) copolymer component (HMW copolymer component) and a lower molecular weight poly(ethylene-co-1-akene) copolymer component (LMW copolymer component). The 1-alkene is the same in the HMW and LMW components. The copolymer is characterized by a unique combination of features comprising, or reflected in, its component weight fraction amount (“split”), density, intermediate load melt index (I₅), high load melt index (I₂₁), melt flow ratio (I₂₁/I₅), molecular weight distribution (Mw/Mn), and hydrostatic pipe strength at elevated temperature and pressure. Embodiments of the copolymer may be characterized by refined or additional features and/or by features of one or both of its HMW and LMW copolymer components.

The single reactor-made bimodal HDPE copolymer is a so-called single reactor-made copolymer because it is made in a single polymerization reactor using a bimodal catalyst system effective for simultaneously making the HMW and LMW copolymer components in situ. The bimodal catalyst system comprises, or is made from, a so-called higher molecular weight-polymerization catalyst effective for making mainly the HMW copolymer component, a lower molecular weight-polymerization catalyst effective for making mainly the LMW copolymer component, a solid support, and an activator. The higher molecular weight-polymerization catalyst and the lower molecular weight-polymerization catalyst operate under identical reactor conditions in a single polymerization reactor.

It is believed that the intimate nature of the blend of the LMW and HMW copolymer components achieved in the single reactor-made bimodal HDPE copolymer by this in situ single reactor polymerization method could not be achieved by separately making the HMW copolymer component in the absence of the LMW copolymer component and separately making the LMW copolymer component in the absence of the HMW copolymer component, and then blending the separately made neat copolymer components together in a post-reactor process.

It is believed that the properties of the single reactor-made bimodal HDPE copolymer made by this in situ single reactor polymerization method would differ from the properties of a dual reactor-made bimodal HDPE copolymer made by a dual reactor process. The dual reactor process comprises making the HMW copolymer component in a first reactor using a first unimodal polymerization catalyst and first reactor conditions, transferring the HMW copolymer component into a second reactor, and making the LMW copolymer component in the second reactor using a second unimodal polymerization catalyst and second reactor conditions to make in situ the dual reactor-made bimodal HDPE copolymer, wherein at least the second unimodal polymerization catalyst or the second reactor conditions of both are different than the first unimodal polymerization catalyst or first reactor conditions or both. Relative to the dual reactor polymerization process, the inventive single reactor polymerization process can yield an inventive single reactor-made bimodal HDPE copolymer having the following improved properties: (a) a lower split (lower weight percent of the HMW copolymer component calculated based on total weight of the HMW and LMW copolymer components, as it is problematic to achieve low splits in dual reactors without hurting productivity in the second reactor; (b) a broader molecular weight distribution (Mw/Mn), especially Mw/Mn of the LMW copolymer component of the inventive single reactor-made bimodal HDPE copolymer; or (c) a lower gel count in the inventive single reactor-made bimodal HDPE copolymer, because higher gel counts can be caused by hot spots in the second reactor of dual reactor systems.

The single reactor-made bimodal HDPE copolymer is especially suitable for making pipes. The inventive single reactor-made bimodal HDPE copolymer has, among other things, a unique balance of properties comprising polydispersity index M_{w}/Mₙ ratio; slow crack growth (“SCG”) resistance at 90° C. of at least 1,000 hours, measured according to Pennsylvania Edge Notch Tensile (“PENT”) Test Method, described later; and hydrostatic pipe strength tested at two different sets of temperature/pressure conditions comprising (i) 110° C./2.83 MPa; and (ii) 95° C./4.39 MPa), measured according to Hydrostatic Pipe Strength Test Method, described later.

The single reactor-made bimodal HDPE copolymer has the blow molding processability and polymer melt strength, and a good combination of stiffness, toughness, impact strength, slow growth crack resistance, and, when made into pipe, hydrostatic pipe strength. This enables manufacturing methods wherein the copolymer is melt-extruded and blow molded into large-part blow molded articles, which are larger, longer, and/or heavier than typical plastic parts. This improved performance enables the copolymer to be used not just for small containers but also for geomembranes, pipes, and tanks. Nevertheless the copolymer is especially suited for being made into PE-RT Type II (rigid) pipes because such pipes can achieve what many PE-RT Type II pipes cannot, which is meet the standard specifications of GB/T 28799:2020.

The inventive single reactor-made bimodal HDPE copolymer achieves this with a lower density. If density of the inventive single reactor-made bimodal HDPE copolymer would be too high, e.g., 0.958 g/cm³ or higher, then its impact performance and/or slow crack growth resistance or hydrostatic pipe strength may be worsened. If density of the inventive single reactor-made bimodal HDPE copolymer would be too low, e.g., 0.940 g/cm³ or lower, then the copolymer may not provide sufficient rigidity to a pipe.

In some embodiments is a single reactor-made bimodal HDPE copolymer comprising from 45.0 weight percent (wt %) to 56.0 wt % of a higher molecular weight poly(ethylene-co-1-akene) copolymer component (HMW copolymer component) and from 55.0 wt % to 44.0 wt %, respectively, of a lower molecular weight poly(ethylene-co-1-akene) copolymer component (LMW copolymer component), wherein the wt % of the HMW copolymer component (commonly referred to as the “split”) and the wt % of the LMW copolymer component are calculated as a percentage of their combined weight from absolute GPC measurements (e.g., made according to GPC Test Method (GPC_{(abs)})); and wherein the copolymer has each of properties (a) to (g): (a) a density from 0.941 gram per cubic centimeter (g/cm³) to 0.957 g/cm³, measured according to ASTM D792-13 (Method B, 2-propanol); (b) a melt index (I₅) from 0.20 to 0.40 grams per 10 minutes (g/10 min.), measured according to ASTM D1238-13 (190° C., 5.0 kg): (c) a high load melt index (HLMI or I₂₁) from 9.0 to 11.0 grams per 10 minutes (g/10 min.), measured according to ASTM D1238-13 (190° C., 21.6 kg); (d) a melt flow ratio (I₂₁/I₅) from 25 to 45; (e) a polydispersity index (“PDI”), M_{z}/M_{w}, from 8.0 to 12.0, wherein M_{z} is z-average molecular weight based on M_{z}(BB) values and M_{w} is weight-average molecular weight, or M_{z}/M_{w}, from 3.5 to 5.2, alternatively from 4.0 to 5.0, wherein M_{z} is z-average molecular weight based on M_{z}(abs) values and M_{w} is as defined above, or both, as measured by absolute gel permeation chromatography, wherein the absolute gel permeation chromatography may be conducted according to Gel Permeation Chromatography (GPC) Test Method (GPC_{(abs)}) described later; (f) a slow crack growth (“SCG”) resistance of at least 5,000 hours, measured at 90° C. according to the Pennsylvania Edge Notch Tensile (“PENT”) Test Method; (g) a first hydrostatic pipe strength of greater than 3,300 hours, measured according to ISO 1167-2 (110° C., 2.83 megapascals (MPa)), or a second hydrostatic pipe strength of greater than 1,400 hours, measured according to ISO 1167-2 (95° C., 4.39 MPa), or both.

In some embodiments the single reactor-made bimodal HDPE copolymer has at least one of the properties (a) to (g): (a) the density is from 0.945 g/cm³ to 0.953 g/cm³, alternatively from 0.947 g/cm³ to 0.951 g/cm³, alternatively from 0.9485 g/cm³ to 0.9494 g/cm³; (b) the melt index (I₅) is from 0.23 to 0.38 g/10 min., alternatively from 0.25 to 0.36 g/10 min., alternatively from 0.27 to 0.34 g/10 min.; (c) the high load melt index (I₂₁) is from 9.2 to 10.6 g/10 min., alternatively from 9.4 to 10.4 g/10 min., alternatively from 9.6 to 10.2 g/10 min.; (d) the melt flow ratio (121/15) is from 23 to 42, alternatively from 25 to 40, alternatively from 28 to 37; (e) the polydispersity index (“PDI”), M_{z}/M_{w}, is from 8.5 to 11.4, alternatively from 8.9 to 10.9, preferably from 9.3 to 10.1, wherein M_{z} is based on M_{z}(BB) values; or M_{z}/M_{w}, from 4.1 to 5.0, alternatively from 4.30 to 4.80 wherein M_{z} is z-average molecular weight based on M_{z}(abs) values and M_{w} is as defined above; or both; (f) the slow crack growth (“SCG”) resistance (PENT) is at least 6,500 hours, alternatively at least 7,100 hours, alternatively at least 7,800 hours; (g) the first hydrostatic pipe strength is either greater than 3,400 hours, alternatively greater than 3,500 hours, alternatively greater than 3,700 hours; or the second hydrostatic pipe strength is greater than 1,500 hours, alternatively greater than 1,600 hours, alternatively greater than 1,800 hours.

In some embodiments the split of the single reactor-made bimodal HDPE copolymer is from 47.0 to 54.0 wt %, alternatively from 47.6 to 52.4 wt % of the HMW copolymer component; and the wt % of the LMW component is from 53.0 to 46.0 wt %, alternatively from 52.4 to 47.6 wt %, respectively.

In some embodiments the single reactor-made bimodal HDPE copolymer is selected from the group consisting of: a single reactor-made bimodal high-density poly(ethylene-co-1-butene) copolymer, a single reactor-made bimodal high-density poly(ethylene-co-1-hexene) copolymer, or a single reactor-made bimodal high-density poly(ethylene-co-1-octene) copolymer; or wherein the single reactor-made bimodal HDPE copolymer is a single reactor-made bimodal high-density poly(ethylene-co-1-hexene) copolymer.

In some embodiments the single reactor-made bimodal HDPE copolymer has a molecular weight selected from the group consisting of: a weight-average molecular weight (M_{w}) from 200,001 grams per mole (g/mol) to 399,999 g/mol, measured by absolute gel permeation chromatography, e.g., according to the GPC Test Method (GPC_{(abs)}); a number-average molecular weight (Mₙ) from 8,001 g/mol to 29,999 g/mol, measured by absolute gel permeation chromatography, e.g., according to the GPC Test Method (GPC_{(abs)}); a z-average molecular weight (M_{z}) from 1,500,001 g/mol to 3,999,999 g/mol, based on M_{z}(BB) values measured by absolute gel permeation chromatography, e.g., according to the GPC Test Method (GPC_{(abs)}); and a combination of any two or three of the molecular weights. In some embodiments, the single reactor-made bimodal HDPE copolymer has an absolute GPC (GPC_{(abs)}) molecular weight selected from the group consisting of: M_{w} from 210,001 g/mol to 299,999 g/mol, alternatively 215,000 g/mol to 239,000 g/mol; Mₙ from 8,101 g/mol to 9,999 g/mol, alternatively 8,250 g/mol to 9,600 g/mol; M_{z} from 1,900,001 g/mol to 2,999,999 g/mol, alternatively 1,950,000 g/mol to 2,499,000 g/mol; and a combination of any two or three of the GPC_{(abs)} molecular weights.

In characterizing the single reactor-made bimodal HDPE copolymer by gel permeation chromatography (GPC), absolute GPC values control, not conventional GPC values.

Examples of such absolute GPC values are M_{z}, M_{w}, Mₙ, M_{w}/Mₙ, M_{z}/M_{w}, and split (wt % of HMW and LMW copolymer components). The absolute GPC values may be measured by absolute gel permeation chromatography, e.g., according to the GPC Test Method (GPC_{(abs)}), described later.

In some embodiments is a method of making the single reactor-made bimodal HDPE copolymer, the method comprising contacting ethylene and 1-alkene with a bimodal catalyst system and a trim catalyst solution in a single gas phase polymerization (GPP) reactor to give the single reactor-made bimodal HDPE copolymer; wherein the bimodal catalyst system bimodal catalyst system comprises a metallocene catalyst, a post-metallocene catalyst, a solid support, and an activator. In some embodiments is the method wherein the metallocene catalyst comprises (n-propylcyclopentadienyl)(tetramethylcyclopentadienyl)zirconium X₂ of formula (I):

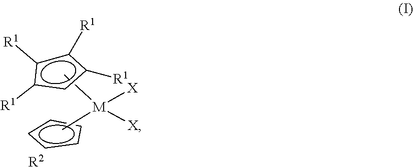

wherein each R¹ is methyl (—CH₃), R² is propyl (—CH₂CH₂CH₃), and each X is a leaving group; and wherein the post-metallocene catalyst comprises bis(2-(pentamethylphenylamido)ethyl)amine zirconium dibenzyl, which is a compound of formula (II)

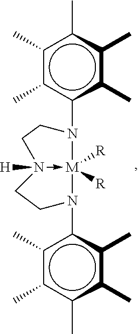

wherein M is Zr and each R is benzyl; and wherein the trim catalyst solution is an additional amount of the metallocene catalyst of formula (I) dissolved in an alkane.

In some embodiments is a single reactor-made bimodal HDPE copolymer made by the method.

In some embodiments is a formulation comprising the single reactor-made bimodal HDPE copolymer and an additive.

In some embodiments is a pipe comprising the single reactor-made bimodal HDPE copolymer or the formulation.

In some embodiments the pipe meets standard specifications of ISO 22391 (2009) or standard specifications of GB/T 28799:2020, as described herein.

In some embodiments the single reactor-made bimodal HDPE copolymer has a third hydrostatic pipe strength of greater than 2,800 hours, measured according to ISO 1167-2 (90° C., 4.75 megapascals (MPa)).

In some embodiments the single reactor-made bimodal HDPE copolymer has a melt index (I₂) less than 0.15 g/10 min. measured at 190° C. and 2.16 kg according to ASTM D1238-13. A melt index (I₂) less than 0.15 g/10 min. is below the minimum value that may be reliably measured by ASTM D1238-13. Thus this value is intended to distinguish the inventive single reactor-made bimodal HDPE copolymer from non-inventive single reactor-made bimodal HDPE copolymers that do have a measurable melt index (I₂) of 0.15 g/10 min. or greater.

The single reactor-made bimodal HDPE copolymer comprises the higher molecular weight poly(ethylene-co-1-akene) copolymer component (HMW copolymer component) and the lower molecular weight poly(ethylene-co-1-akene) copolymer component (LMW copolymer component). The “higher” and “lower” descriptions mean the weight-average molecular weight of the HMW copolymer component (M_{wH}) is greater than the weight-average molecular weight of the LMW copolymer component (M_{wL}).

The single reactor-made bimodal HDPE copolymer is characterized by a bimodal weight-average molecular weight distribution (bimodal M_{w} distribution) as determined by absolute gel permeation chromatography (GPC), wherein the absolute gel permeation chromatography may be conducted according to the GPC Test Method (GPC_{(abs)}) described later. The bimodal M_{w} distribution is not unimodal because the copolymer is made by two distinctly different catalysts of the bimodal catalyst system. The copolymer may be characterized by two peaks in a plot of dW/d Log(MW) on the y-axis versus Log(MW) on the x-axis to give a Gel Permeation Chromatography (GPC) chromatogram, wherein Log(MW) and dW/d Log(MW) are as defined herein and are measured by absolute GPC, wherein the absolute GPC may be conducted according to the GPC Test Method (GPC_{(abs)}) described later. The two peaks may be separated by a distinguishable local minimum therebetween or one peak may merely be a shoulder on the other.

Mathematical definition of absolute GPC molecular weight distribution properties. The bimodal molecular weight distribution (bimodal MWD) of the single reactor-made bimodal HDPE copolymer may be in a range of Log(molecular weight) from 3.5 to 6.0 in a chromatogram obtained from absolute GPC (absolute GPC chromatogram). This bimodal MWD may appear visually as two peaks and a local minimum (“valley”) therebetween in the absolute GPC chromatogram. Although visual observation may be sufficient to determine properties such as the heights of the peaks and the height of the valley, and the split of the single reactor-made bimodal HDPE copolymer, these properties may be more rigorously defined mathematically. What follows is a description of such a mathematical definition. Thus, in some embodiments the bimodal molecular weight distribution of the single reactor-made bimodal HDPE copolymer has a molecular weight distribution determined from absolute gel permeation chromatography (“Absolute GPC”), where this Absolute GPC as a first peak, a local minimum, and a second peak in a range of Log(molecular weight), wherein the local minimum is an inflection point between the first peak and the second peak, and the first peak corresponds to the low molecular weight component and the second peak corresponds to the high molecular weight component. Within this range of Log(molecular weight), a first and then second derivative of the equally spaced data produces three inflexion points for a molecular weight distribution. Two positive inflexion points, derivative values going from positive to negative values as Log(molecular weight) increases, and one negative inflexion point, derivative values going from negative to positive as Log(molecular weight) increases. The local minimum is located between the first peak and the second peak. The first peak, which can be designated as the local maximum (Mmax1), is the molecular weight at the inflexion point that corresponds to the lower molecular weight polyethylene component and the second peak, which can be designated as the local maximum (Mmax2), is the molecular weight at the inflexion point that corresponds to the higher molecular weight polyethylene component. The local minimum, whether or not a distinct “valley” is present, is the lowest molecular weight value between the first peak and the second peak and is the negative inflection point between the first peak and the second peak. This mathematical definition may be used to determine absolute GPC molecular weight distribution properties such as split, location of Log(MW) minima between peaks of HMW and LMW components (GPC_{(abs)}), ratio HMW component peak height/minima (GPC_{(abs)}), and ratio LMW Component Peak height/minima (GPC_{(abs)}). The absolute GPC chromatogram relates to the molecular architecture of the single reactor-made bimodal HDPE copolymer. The molecular architecture, in part, is result of the particular bimodal catalyst system used to form the copolymer. It has been found that, according to embodiments disclosed herein, a particular type of bimodal catalyst system is suitable for producing the single reactor-made bimodal HDPE copolymer in a single reactor and for delivering a specific or “fingerprint” absolute GPC chromatogram, whereas prior art polymers with similar features or different catalyst systems cannot be made in a single reactor system, nor delver the specific or “fingerprint” absolute GPC chromatogram, nor deliver the other copolymer resin properties disclosed herein.

The 1-akene used to make the inventive single reactor-made bimodal HDPE copolymer may be any alpha-olefin. For practical reasons propene or a (C₄-C₂₀)alpha-olefin is typically used. For use in PE-RT Type II pipes, a (C₄-C₈)alpha-olefin, or a combination of any two or more (C₄-C₈)alpha-olefins is typically used. In some embodiments the (C₄-C₈)alpha-olefin independently may be 1-butene, 1-pentene, 1-hexene, 4-methyl-1-pentene, 1-heptene, or 1-octene; alternatively 1-butene, 1-hexene, or 1-octene; alternatively 1-butene or 1-hexene; alternatively 1-hexene or 1-octene; alternatively 1-butene; alternatively 1-hexene; alternatively 1-octene; alternatively a combination of 1-butene and 1-hexene; alternatively a combination of 1-hexene and 1-octene. Typically the 1-alkene may be 1-hexene.

The single reactor method of making the single reactor-made bimodal HDPE copolymer comprises gas phase polymerization of ethylene and the 1-alkene in a single gas phase polymerization reactor using a bimodal catalyst system. The method makes both the HMW and LMW polyethylene components in situ in the same gas phase polymerization reactor at the same time under the same process conditions using the same bimodal catalyst system. An example of a suitable bimodal catalyst system is the bimodal catalyst system provided under the PRODIGY™ BMC-200 trademark or can be produced as described in one or more of the following patents and applications: US 2007/0043177 A1; US 2009/0036610 A1; US 2020/0071509 A1, WO 2009/148487 A1, WO 2019/241045 A1, WO 2020/046663 A1, and WO 2020/068413 A1; U.S. Pat. Nos. 5,539,076; 5,882,750; 6,403,181 B1; U.S. Pat. Nos. 7,090,927; 8,110,644 B2; 8,378,029 B2; and US 2020/0024376 A1.

The PRODIGY™ BMC-200 catalyst system comprises, or is made from, a zirconium-containing metallocene catalyst, a zirconium-containing post-metallocene catalyst, a support material, and an activator. The zirconium-containing metallocene catalyst is (n-propylcyclopentadienyl)(tetramethylcyclopentadienyl)zirconium X₂ of formula (I):

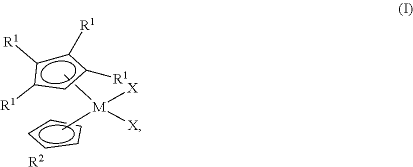

wherein each R¹ is methyl (—CH₃) and R² is propyl (—CH₂CH₂CH₃) and each X is a leaving group. In some embodiments of formula (I) each X is Cl or each X is methyl. The zirconium-containing post-metallocene catalyst is bis(2-(pentamethylphenylamido)ethyl)amine zirconium dibenzyl, which is sometimes referred to in the art as “HN5 dibenzyl” and is a compound of formula (II)

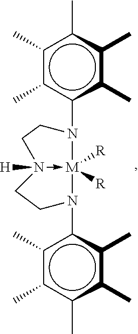

wherein M is Zr and each R is benzyl (“Bn”). Both catalysts are well known in the art. For example, the zirconium-containing post-metallocene catalyst may be made by procedures described in the art or obtained from Univation Technologies, LLC, Houston, Texas, USA, a wholly-owned entity of The Dow Chemical Company, Midland, Michigan, USA. Representative Group 15-containing metal compounds, including bis(2-(pentamethylphenylamido)ethyl)amine zirconium dibenzyl, and preparation thereof can be as discussed and described in U.S. Pat. Nos. 5,318,935; 5,889,128; 6,333,389; 6,271,325; 6,689,847; and 9,981,371; and WO Publications WO 99/01460; WO 98/46651; WO 2009/064404; WO 2009/064452; and WO 20091064482.

Without being bound by theory, it is believed that the bis((alkyl-substituted phenylamido)ethyl)amine catalyst (e.g., the bis(2-(pentamethylphenylamido)ethyl)amine zirconium dibenzyl) is a substantially single-site non-metallocene catalyst that is effective for making the HMW copolymer component of the single reactor-made bimodal HDPE copolymer and the metallocene catalyst (made from the metal-ligand complex of formula (I)) is a substantially single-site catalyst that is independently effective for making the LMW copolymer component of the single reactor-made bimodal HDPE copolymer. The molar ratio of the two catalysts of the bimodal catalyst system may be based on the molar ratio of their respective catalytic metal atom (M, e.g., Zr) contents, which may be calculated from ingredient weights thereof or may be analytically measured. The molar ratio of the two catalysts may be varied in the polymerization method by way of using a different bimodal catalyst system formulation having different molar ratio thereof or by using a same bimodal catalyst system and the trim catalyst solution. Varying the molar ratio of the two catalysts during the polymerization method may be used to vary the particular properties of the single reactor-made bimodal HDPE copolymer within the limits of the described features thereof.

The PRODIGY™ BMC-200 embodiment of the bimodal catalyst system was used to make the comparative and inventive single reactor-made bimodal HDPE copolymers in the EXAMPLES.

Another example of a suitable bimodal catalyst system that can be used to make the single reactor-made bimodal HDPE copolymer is the bimodal catalyst system provided under the PRODIGY™ BMC-300 trademark or can be produced as described in the patents above and in US Application 2020/0024376 A1. The PRODIGY™ BMC-300 catalyst system comprises, or is made from, a zirconium-containing metallocene catalyst, a zirconium-containing post-metallocene catalyst, a support material, and an activator. The zirconium-containing metallocene catalyst Is bis(n-butylcyclopentadienyl)zirconium X₂ of formula (III):

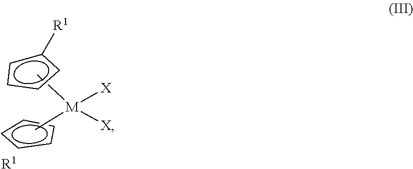

wherein each R¹ is —CH₂CH₂CH₂CH₃ and each X is a leaving group. In some embodiments of formula (III) each X is Cl or each X is methyl. The zirconium-containing post-metallocene catalyst is the HN5 dibenzyl.

Another suitable embodiment of the bimodal catalyst system is made from the same constituents as used to make the BMC-300 type catalyst system except wherein the bis(n-butylcyclopentadienyl)zirconium X₂ of formula (III) is replaced by (cyclopentadienyl)(1,5-dimethylindenyl)zirconium X₂, which is a zirconium-containing metallocene of formula (IV):

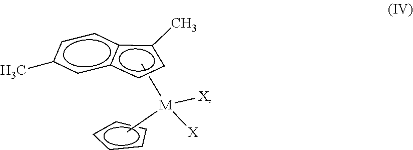

wherein M is Zr and each X is a leaving group. In some embodiments of formula (IV) each X is Cl or each X is methyl. This other suitable bimodal catalyst system thus comprises, or is made from, the zirconium-containing metallocene of formula (IV), the HN5 dibenzyl, the support, and an activator. For convenience herein, this other embodiment of the bimodal catalyst system is called “BMC Analog”.

The catalysts of the bimodal catalyst system may be unsupported when contacted with an activator, which may be the same or different for the different catalysts. Alternatively, the catalysts may be disposed by spray-drying onto a solid support material prior to being contacted with the activator(s). The solid support material may be uncalcined or calcined prior to being contacted with the catalysts. The solid support material may be a hydrophobic fumed silica (e.g., a fumed silica treated with dimethyldichlorosilane). The bimodal (unsupported or supported) catalyst system may be in the form of a powdery, free-flowing particulate solid.

The support material used in these bimodal catalyst systems may be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 20 to 300 micrometers (μm). Alternatively, the pore volume is from 0.5 to 6.0 cubic centimeters per gram (cc/g) and the surface area is from 200 to 600 m²/g. Alternatively, the pore volume is from 1.1 to 1.8 cc/g and the surface area is from 245 to 375 m²/g. Alternatively, the pore volume is from 2.4 to 3.7 cc/g and the surface area is from 410 to 620 m²/g. Alternatively, the pore volume is from 0.9 to 1.4 cc/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, such as the HN5 dibenzyl and the zirconium-containing metallocene, the support material may be pre-treated by heating the support material in air to give a calcined support material. The pre-treating comprises heating the support material at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined support material. The support material may be a calcined support material.

The method of making the single reactor-made bimodal HDPE copolymer using the bimodal catalyst system may further employ a trim catalyst, typically in the form of a trim catalyst solution comprising the aforementioned zirconium-containing metallocene of formula (I) and an additional quantity of activator. For convenience the trim catalyst is fed in solution in a hydrocarbon solvent (e.g., mineral oil, heptane, or isopentane). The trim catalyst may be used to vary, within limits, the amount of the zirconium-containing metallocene used in the method relative to the amount of the zirconium-containing post-metallocene (e.g., HN5 dibenzyl) of the bimodal catalyst system, so as to adjust the properties of the inventive single reactor-made bimodal HDPE copolymer.

Each catalyst of the bimodal catalyst system is activated by contacting it with an activator. Any activator may be the same or different as another and independently may be a Lewis acid, a non-coordinating ionic activator, or an Ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Zr) may be 1000:1 to 0.5:1, alternatively 300:1 to 1:1, alternatively 150:1 to 1:1. Suitable activators are commercially available.

Once the activator and the catalysts of the bimodal catalyst system contact each other, the catalysts of the bimodal catalyst system are activated and activator species may be made in situ. The activator species may have a different structure or composition than the catalyst and activator from which it is derived and may be a by-product of the activation of the catalyst or may be a derivative of the by-product. The corresponding activator species may be a derivative of the Lewis acid, non-coordinating ionic activator, ionizing activator, Lewis base, alkylaluminum, or alkylaluminoxane, respectively. An example of the derivative of the by-product is a methylaluminoxane species that is formed by devolatilizing during spray-drying of a bimodal catalyst system made with methylaluminoxane.

Each contacting step between activator and catalyst of the bimodal catalyst system independently may be done either in a separate vessel outside of a single gas phase polymerization (GPP) reactor, such as outside of a single floating-bed gas phase polymerization (FB-GPP) reactor, or in a feed line to the GPP reactor. The bimodal catalyst system, once its catalysts are activated, may be fed into the GPP reactor as a dry powder, alternatively as a slurry in a non-polar, aprotic (hydrocarbon) solvent. The activator(s) may be fed into the GPP reactor in “wet mode” in the form of a solution thereof in an inert liquid such as mineral oil or toluene, in slurry mode as a suspension, or in dry mode as a powder. Each contacting step may be done at the same or different times.

The single gas phase polymerization reactor may be a single fluidized-bed gas phase polymerization (FB-GPP) reactor and the effective polymerization conditions may comprise the following reaction conditions: the FB-GPP reactor having a fluidized bed at a bed temperature from 80 to 110 degrees Celsius (° C.); the FB-GPP reactor receiving feeds of respective independently controlled amounts of ethylene, 1-akene characterized by a 1-akene-to-ethylene (Cₓ/C₂, wherein subscript x indicates the number of carbon atoms in the 1-alkene; for example, when the 1-akene is 1-hexene, the Cₓ/C₂ ratio is the 1-hexene-to-ethylene ratio, which may be written as a C₆/C₂ ratio) molar ratio, the bimodal catalyst system, optionally a trim catalyst solution, optionally hydrogen gas (H₂) characterized by a hydrogen-to-ethylene (H₂/C₂) molar ratio or by a weight parts per million H₂ to mole percent C₂ ratio (H₂ ppm/C₂ mol %), and optionally an induced condensing agent (ICA) comprising a (C₅-C₁₀)alkane(s), e.g., isopentane; wherein the (C₆/C₂) molar ratio is from 0.0010 to 0.1; and wherein when the ICA is fed, the concentration of ICA in the reactor is from 1 to 20 mole percent (mol %), based on total moles of ethylene, 1-akene, and ICA in the reactor. The average residence time of the copolymer in the reactor may be from 1.0 to 4.0 hours. A continuity additive may be used in the FB-GPP reactor during polymerization. In some embodiments the reaction conditions are those described in the EXAMPLES for making the inventive single reactor-made bimodal HDPE copolymer, plus-or-minus (±) 10%.

In an illustrative pilot plant process for making the single reactor-made bimodal polyethylene polymer, a single fluidized bed, gas-phase polymerization reactor (“FB-GPP reactor”) having a reaction zone dimensioned as 304.8 mm (twelve inch) internal diameter and a 2.4384 meter (8 feet) in straight-side height and containing a fluidized bed of granules of the single reactor-made bimodal polyethylene polymer. Configure the FB-GPP reactor with a recycle gas line for flowing a recycle gas stream. Fit the FB-GPP reactor with gas feed inlets and polymer product outlet. Introduce gaseous feed streams of ethylene and hydrogen together with 1-alkene comonomer (e.g., 1-hexene) below the FB-GPP reactor bed into the recycle gas line. Measure the (C₅-C₂₀)alkane(s) total concentration in the gas/vapor effluent by sampling the gas/vapor effluent in the recycle gas line. Return the gas/vapor effluent (other than a small portion removed for sampling) to the FB-GPP reactor via the recycle gas line.

Polymerization operating conditions are any variable or combination of variables that may affect a polymerization reaction in the FB-GPP reactor or a composition or property of a single reactor-made bimodal polyethylene copolymer made thereby. The variables may include reactor design and size, catalyst composition and amount; reactant composition and amount; molar ratio of two different reactants; presence or absence of feed gases such as H₂ and/or O₂, molar ratio of feed gases versus reactants, absence or concentration of interfering materials (e.g., H₂O), average polymer residence time in the reactor, partial pressures of constituents, feed rates of monomers, reactor bed temperature (e.g., fluidized bed temperature), nature or sequence of process steps, time periods for transitioning between steps. Variables other than that/those being described or changed by the method or use may be kept constant.

In operating the method, control individual flow rates of ethylene (“C₂”), 1-akene (“Cₓ”, e.g., 1-hexene or “C₆” or “Cₓ” wherein x is 6), and any hydrogen (“H₂”) to maintain a fixed comonomer to ethylene monomer gas molar ratio (Cₓ/C₂, e.g., C₆/C₂) equal to a described value, a constant hydrogen to ethylene gas molar ratio (“H₂/C₂”) equal to a described value, and a constant ethylene (“C₂”) partial pressure equal to a described value (e.g., 1,500 kPa). Measure concentrations of gases by an in-line gas chromatograph to understand and maintain composition in the recycle gas stream. Maintain a reacting bed of growing polymer particles in a fluidized state by continuously flowing a make-up feed and recycle gas through the reaction zone. Use a superficial gas velocity of 0.43 to 0.67 meter per second (m/sec). Operate the FB-GPP reactor at a total pressure of about 2344 to about 2420 kilopascals (kPa) (about 340 to about 351 pounds per square inch-gauge (psig)) and at a described reactor bed temperature RBT. Maintain the fluidized bed at a constant height by withdrawing a portion of the bed at a rate equal to the rate of production of particulate form of the single reactor-made bimodal polyethylene polymer, which production rate may be from 2 to 20 kilograms per hour (kg/hr). Remove the produced single reactor-made bimodal HDPE copolymer semi-continuously via a series of valves into a fixed volume chamber, and purge the removed composition with a stream of humidified nitrogen (N₂) gas to remove entrained hydrocarbons and deactivate any trace quantities of residual catalysts.

An induced condensing agent (ICA) may be employed in the single FB-GPP reactor. The ICA may be fed separately into the FB-GPP reactor or as part of a mixture also containing the bimodal catalyst system. The ICA may be a (C₅-C₂₀)alkane, alternatively a (C₅-C₁₀)alkane, alternatively a (C₅)alkane, e.g., pentane or 2-methylbutane; a hexane; a heptane; an octane; a nonane; a decane; or a combination of any two or more thereof. Typically the ICA is isopentane (2-methylbutane). The aspects of the polymerization method that use the ICA may be referred to as being an induced condensing mode operation (ICMO). ICMO is described in U.S. Pat. Nos. 4,453,399; 4,588,790; 4,994,534; 5,352,749; 5,462,999; and 6,489,408. The concentration of ICA in the reactor is measured indirectly as total concentration of vented ICA in recycle line using gas chromatography by calibrating peak area percent to mole percent (mol %) with a gas mixture standard of known concentrations of ad rem gas phase components.

The method uses a single gas-phase polymerization (GPP) reactor, such as a single stirred-bed gas phase polymerization reactor (SB-GPP reactor) or a single fluidized-bed gas-phase polymerization reactor (FB-GPP reactor), to make the single reactor-made bimodal HDPE copolymer. Such gas phase polymerization reactors and methods are generally well-known in the art. For example, the FB-GPP reactor/method may be as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

The polymerization conditions may further include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The polymerization conditions for gas phase polymerization reactor/method may further include an amount (e.g., 0.5 to 200 ppm based on all feeds into reactor) of a static control agent and/or a continuity additive such as a metal stearate, e.g., aluminum stearate; or polyethyleneimine. The static control agent may be added to the FB-GPP reactor to inhibit formation or buildup of static charge therein.

The method may use a single fluidized bed gas phase polymerization reactor that comprises a reactor vessel containing a fluidized bed of a powder of the single reactor-made bimodal polyethylene polymer, and a distributor plate disposed above a bottom head, and defining a bottom gas inlet, and having an expanded section, or cyclone system, at the top of the reactor vessel to decrease amount of resin fines that may escape from the fluidized bed. The expanded section defines a gas outlet. The reactor further comprises a compressor blower of sufficient power to continuously cycle or loop gas around from out of the gas outlet in the expanded section in the top of the reactor vessel down to and into the bottom gas inlet of the reactor and through the distributor plate and fluidized bed. The reactor further comprises a cooling system to remove heat of polymerization and maintain the fluidized bed at a target temperature. Compositions of gases such as ethylene, 1-alkene (e.g., 1-hexene), and hydrogen being fed into the reactor are monitored by an in-line gas chromatograph in the cycle loop in order to maintain specific concentrations thereof that define and enable control of polymer properties. The bimodal catalyst system may be fed as a slurry or dry powder into the reactor from high pressure devices, wherein the slurry is fed via a syringe pump and the dry powder is fed via a metered disk. The bimodal catalyst system typically enters the fluidized bed in the lower ⅓ of its bed height. The reactor also comprises a way of weighing the fluidized bed and isolation ports (a product discharge system) for discharging the powder of single reactor-made bimodal polyethylene polymer from the reactor vessel in response to an increase of the fluidized bed weight as polymerization reaction proceeds.

In some embodiments the FB-GPP reactor is a commercial scale reactor such as a UNIPOL™ reactor, which is available from Univation Technologies, LLC, a subsidiary of The Dow Chemical Company, Midland, Michigan, USA.

The polymerization method may further employ a trim catalyst, typically in the form of a trim catalyst solution as described elsewhere herein. The trim catalyst may be the metallocene catalyst of formula (I). For convenience the trim catalyst is fed in solution in a hydrocarbon solvent (e.g., mineral oil or heptane). The hydrocarbon solvent may be the ICA. Alternatively the trim catalyst may be a different zirconium metallocene catalyst than the metallocene catalyst of the bimodal catalyst system. The trim catalyst may be used to vary, within limits, the amount of the metallocene catalyst used in the method relative to the amount of the single-site non-metallocene catalyst of the bimodal catalyst system.

Without being bound by theory, it is believed that the characteristic features and resulting improved processability and performance of the single reactor-made bimodal HDPE copolymer are believed to be imparted by a unique combination of the choice of bimodal catalyst system (designated “PRODIGY™ BMC-200” in the inventive examples) and a controlled relative amount of a trim catalyst solution (designated “TCS1” in the inventive examples) and controlled gas-phase polymerization conditions that are used to make the inventive single reactor-made bimodal HDPE copolymer.

The formulation comprises the single reactor-made bimodal HDPE copolymer and an additive. The additive may be an antioxidant, an anti-scorch agent, a filer, a hindered amine stabilizer, a colorant, a carrier resin, a lubricant, a processing aid, a slip agent, a plasticizer, a surfactant, an extender oil, a metal deactivator, or a combination of any two or more of these additives. The additives combination may be any two or more of the same additive, such as a combination of two or more antioxidants; or any two or more of different additives, such as an antioxidant and a hindered amine stabilizer; or both.

The antioxidant is an organic molecule, or a mixture of molecules, that inhibits oxidation. The antioxidant functions to provide antioxidizing properties to the copolymer and formulation. Examples of suitable antioxidants are bis(4-(1-methyl-1-phenylethyl)phenyl)amine (e.g., NAUGARD 445); 2,2′-methylene-bis(4-methyl-6-t-butylphenol) (e.g., VANOX MBPC); 2,2′-thiobis(2-t-butyl-5-methylphenol (CAS No. 90-66-4; 4,4′-thiobis(2-t-butyl-5-methylphenol) (also known as 4,4′-thiobis(6-tert-butyl-m-cresol), CAS No. 96-69-5, commercially LOWINOX TBM-6); 2,2′-thiobis(6-t-butyl-4-methylphenol (CAS No. 90-66-4, commercially LOWINOX TBP-6); tris[(4-tert-butyl-3-hydroxy-2,6-dimethylphenyl)methyl]-1,3,5-triazine-2,4,6-trione (e.g., CYANOX 1790); pentaerythritol tetrakis(3-(3,5-bis(1,1-dimethylethyl)-4-hydroxyphenyl)propionate (e.g., IRGANOX 1010, CAS Number 6683-19-8); 3,5-bis(1,1-dimethylethyl)-4-hydroxybenzenepropanoic acid 2,2′-thiodiethanediyl ester (e.g., IRGANOX 1035, CAS Number 41484-35-9); distearyl thiodipropionate (“DSTDP”); dilauryl thiodipropionate (e.g., IRGANOX PS 800); stearyl 3-(3,5-di-t-butyl-4-hydroxyphenyl)propionate (e.g., IRGANOX 1076); 2,4-bis(dodecylthiomethyl)-6-methylphenol (IRGANOX 1726); 4,6-bis(octylthiomethyl)-o-cresol (e.g. IRGANOX 1520); and 2′,3-bis[[3-[3,5-di-tert-butyl-4-hydroxyphenyl]propionyl]]propionohydrazide (IRGANOX 1024). The formulation may be free of antioxidant, although typically an antioxidant is used when the formulation is used to manufacture articles that will be exposed to air. When present in the formulation each antioxidant independently may be from 0.01 to 1.5 wt %, alternatively 0.05 to 1.2 wt %, alternatively 0.1 to 1.0 wt % of the formulation.

The hindered amine stabilizer is a molecule, or a mixture of different molecules, that contains a basic nitrogen atom that is bonded to at least one sterically bulky organo group and functions as an inhibitor of degradation or decomposition of the single reactor-made bimodal HDPE copolymer. Examples of suitable hindered amine stabilizers are butanedioic acid dimethyl ester, polymer with 4-hydroxy-2,2,6,6-tetramethyl-1-piperidine-ethanol (CAS No. 65447-77-0, commercially LOWILITE 62); and N,N′-bisformyl-N,N′-bis(2,2,6,6-tetramethyl-4-piperidinyl)-hexamethylenediamine (CAS No. 124172-53-8, commercially Uvinul 4050 H). In some aspects the formulation is free of hindered amine stabilizer. When present, the hindered amine stabilizer may be from 0.001 to 1.5 wt %, alternatively 0.002 to 1.2 wt %, alternatively 0.002 to 1.0 wt %, alternatively 0.005 to 0.5 wt %, alternatively 0.01 to 0.2 wt %, alternatively 0.05 to 0.1 wt % of the formulation.

The filler is a finely-divided particulate inorganic solid or gel that occupies space in, and optionally affects function of, a host material. The filler may be a calcined clay, an organoclay, or a hydrophobized fumed silica. The silica includes those commercially available under the CAB-O-SIL trade name from Cabot Corporation. The filer may be selected from the group consisting of aluminum oxide, aluminum silicate, calcium silicate, magnesium silicate, silica, titanium dioxide, and mixtures thereof. For avoidance of doubt, the term “inorganic filler” does not include carbon black. In some aspects the formulation is free of the filler. When present, the filler may be 1 to 40 wt %, alternatively 2 to 30 wt %, alternatively 5 to 20 wt % of the formulation.

The colorant is a material that changes the color of the formulation from the “natural color” of the single reactor-made bimodal HDPE copolymer to a colored version such as black (wherein the colorant is e.g., carbon black) or white (e.g., wherein the colorant is TiO₂). Carbon black: a finely-divided form of paracrystalline carbon having a high surface area-to-volume ratio, but lower than that of activated carbon. Examples of carbon black are furnace carbon black, acetylene carbon black, conductive carbons (e.g., carbon fibers, carbon nanotubes, graphene, graphite, and expanded graphite platelets). In some aspects the formulation is free of colorant, although typically a colorant is included when the formulation is used to manufacture articles that will be exposed to ultraviolet light (e.g., sunlight). When present, the colorant may be in a concentration of from 0.01 to 10 wt %, alternatively 0.05 to 5 wt %, alternatively 0.1 to 2 wt %, alternatively 0.5 to 1 wt % of the formulation.

The carrier resin is a polyethylene. One or more of the additives may be introduced into the single reactor-made bimodal HDPE copolymer in the form of an additive masterbatch comprising the carrier resin and one or more of the additives. The masterbatch method makes it easier to homogenize difficult-to-mix additives, such as carbon black, into the single reactor-made bimodal HDPE copolymer. In some embodiments the formulation is free of the carrier resin. If the carrier resin is present in the formulation, its source is from an additive masterbatch.

The method of making a manufactured article from the single reactor-made bimodal HDPE copolymer or the formulation comprises melt extruding the copolymer or formulation into a shaped form, such as a pipe. Methods of manufacturing articles of polyethylenes are well known and can be adapted for use with the single reactor-made bimodal HDPE copolymer or the formulation. In some embodiments the method comprises making a pipe. The method of manufacturing the pipe comprises melt extruding the copolymer or formulation through an annular die, and allowing the resulting extruded cylinder to cool, or cooling same, thereby making the pipe.

A manufactured article comprising the single reactor-made bimodal HDPE copolymer or the formulation. In some embodiments the manufactured article comprises a pipe. The pipe may be of the PE-RT Type II rigid type.

Hydrophobic fumed silica. A hydrophobic fumed silica is a product of pre-treating a hydrophilic fumed silica (untreated) with a silicon-based hydrophobing agent selected from trimethylsilyl chloride, dimethyldichlorosilane, a polydimethylsiloxane fluid, hexamethyldisilazane, an octyltriakoxysilane (e.g., octyltrimethoxysilane), and a combination of any two or more thereof; alternatively dimethyldichlorosilane. Examples of the hydrophobic fumed silica are CAB-O-SIL hydrophobic fumed silicas available from Cabot Corporation, Alpharetta Georgia, USA. When the hydrophobing agent is dimethyldichlorosilane, an example of a hydrophobic fumed silica is CAB-O-SIL TS610 from Cabot Corporation.

Alternatively precedes a distinct embodiment. ASTM means the standards organization, ASTM International, West Conshohocken, Pennsylvania, USA. Any comparative example is used for illustration purposes only and shall not be prior art. Free of or lacks means a complete absence of; alternatively not detectable. ISO is International Organization for Standardization, Chemin de Blandonnet 8, CP 401-1214 Vernier, Geneva, Switzerland. IUPAC is International Union of Pure and Applied Chemistry (IUPAC Secretariat, Research Triangle Park, North Carolina, USA). May confers a permitted choice, not an imperative. Operative means functionally capable or effective. Optional(ly) means is absent (or excluded), alternatively is present (or included). PAS is Publicly Available Specification, Deutsches Institut für Normunng e.V. (DIN, German Institute for Standardization) Properties may be measured using standard test methods and conditions. Ranges include endpoints, subranges, and whole and/or fractional values subsumed therein, except a range of integers does not include fractional values. Room temperature: 23° C.±1° C.

Terms used herein have their IUPAC meanings unless defined otherwise. For example, see Compendium of Chemical Terminology. Gold Book, version 2.3.3, Feb. 24, 2014.

If a discrepancy arises between a claimed range for M_{z} and/or a claimed range for M_{w} and a claimed range for M_{z}/M_{w} ratio, the claimed range for M_{z}/M_{w} ratio controls. If a discrepancy arises between a claimed range for M_{w} and/or a claimed range for Mₙ and a claimed range for M_{w}/Mₙ ratio, the claimed range for M_{w}/Mₙ ratio controls.

The single reactor-made bimodal HDPE copolymer is characterized by certain properties as described herein. These properties may be measured with solid copolymer (e.g., density), or a solution of copolymer (e.g., GPC molecular weights), or a melt of the copolymer (e.g., melt indexes), or a manufactured article of the copolymer (e.g., pipe). The test methods for making these measurements are described below.

Density is measured according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

### Absolute Gel Permeation Chromatography (GPC) Test Method.

The chromatographic system consists of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 160° Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 1. Processing of the flow marker peak was done via the PolymerChar GPCOne™ Software. Acceptable flowrate correction is such that the effective flowrate should be within +/−0.5% of the nominal flowrate.

Flowrate(effective)=Flowrate(nominal)*(RV(FM Calibrated)/RV(FM Sample)) EQ. 1.

For the determination of the viscometer and light scattering detector offsets from the IR5 detector, the Systematic Approach for the determination of multi-detector offsets is done in a manner consistent with that published by Balke, Mourey, et. al. (Mourey and Bake, Chromatography Polym. Chpt 12, (1992)) (Bake, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16,1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475 (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (M_{w}(Abs)) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). The M_{w}(Abs) and the respective moments, Mₙ(Abs) and M_{z}(Abs) are be calculated according to the following respective Equations 2 to 4 (EQ. 2 to EQ. 4):

$${M}_{n} ( abs ) = \frac{{\sum }^{i} {IR}_{i}}{{\sum }^{i} ( {IR}_{i} / {M}_{absolute} )} \qquad EQ . 2$$

$${M}_{w} ( abs ) = \frac{{\sum }^{i} {IR}_{i} \times {M}_{{Absolute}_{i}}}{{\sum }^{i} {IR}_{i}} \qquad EQ . 3$$

$${M}_{w} ( abs ) = \frac{( {\sum }^{i} {IR}_{i} \times {{M}_{{Absolute}_{i}}}^{2} )}{( {\sum }^{i} {IR}_{i} \times {M}_{{Absolute}_{i}} )} \qquad EQ . 4$$

M_{z} based on M_{z}(BB) is calculated according to the following Equation 5:

$${{M}_{z} ( BB )}_{LS} = \frac{{\sum }^{i} {IR}_{i} * {M}_{i , LS} * {M}_{i , CC}}{{\sum }^{i} {IR}_{i} * {M}_{i , LS}} = \frac{{\sum }_{i} {LS}_{i} * {M}_{i , CC}}{{\sum }_{i} {LS}_{i}} \qquad EQ . 5$$

wherein M_{z}(BB) is z-average molecular weight determined by incorporating backbone (“BB”) weight of the polymer's longest molecular chain (and to which short-chain branches and long-chain branches are bonded); LSi is the absolute molecular weight data point at every chromatographic slice; and Mi,CC is the conventional molecular weight at every chromatographic slice. The conventional molecular weight is measured according to the conventional GPC test method described later.

Deconvolution of Absolute GPC Chromatogram—The fitting of the absolute GPC chromatogram into a high molecular weight (HMW) and low molecular weight (LMW) component fraction was accomplished using a Flory distribution which was broadened with a normal distribution function as follows: For the log M axis, 601 equally-spaced Log(M) points, spaced by 0.01, were established between 2 and 8 representing the molecular weight range between 100 and 100,000,000 where Log is the logarithm function to the base 10. At any given Log (M), the population of the Flory distribution was in the form of Eq. 6:

$${dW}_{f} / d Log M = {( \frac{2}{{M}_{w}} )}^{3} ( \frac{{M}_{w}}{0.868588961964} ) {M}^{2} {e}^{( - 2 M / {M}_{w} )} \qquad EQ . 6$$

where Mw is the absolute weight-average molecular weight of the Flory distribution and M is the specific x-axis absolute molecular weight point, (10\hat{ }[Log(M)]). The Flory distribution weight fraction was broadened at each 0.01 equally-spaced log(M) index according to a normal distribution function, of width expressed in Log(M), σ; and current M index expressed as Log(M), μ.

$${f}_{( LogM , μ , σ )} = {e}^{- \frac{( LogM - μ )}{2 {σ}^{2}}} \qquad EQ . 7$$

It should be noted that before and after the spreading function has been applied that the area of the distribution (dW₁/d Log M) as a function of Log(M) is normalized to unity. Two weight-fraction distributions, dW_{f1} and dW_{f2}, for LMW and HMW components or components 1 and 2 were expressed with two unique Mw target values, Mw₁ and Mw₂ and with overall component compositions A₁ and A₂, where each composition weight % is quantified by the known reactor split in the process. Both distributions were broadened with the same width, s. The two distributions were summed as follows:

dW_{f}/d Log M=A₁dW_{f1}/d Log M+A₂dW_{f2}/d Log M Eq.8
where: A₁+A₂=1.

The weight fraction result of the measured absolute GPC molecular weight distribution was interpolated along 601 log M points using a 2^{nd}-order polynomial. Microsoft Excel™ 2010 Solver was used to minimize the sum of squares of residuals for the equally-spaces range of 601 Log M points between the interpolated chromatographically determined molecular weight distribution and the two broadened Flory distribution components (s₁ and s₂), weighted with their respective component compositions, A₁ and A₂. The iteration starting values for the components are as follows:

Component 1: Mw₁=17,000, s=0.200, and A₁=0.5.

Component 2: Mw₂=300,000, s=0.200, and A₂=1−A₁.

(Note s₁=s₂ and A₁+A₂=1).

The bounds for components 1 and 2 are such that s is constrained such that s>0.001, yielding an Mw/Mn of approximately 2.00 and s<0.550, yielding a Mw/Mn of approximately 5.71. The composition, A₁, is constrained between 0.000 and 1.000. The Mw₁ is constrained between 2,500 and 2,000,000. The composition, A₂, is constrained between 0.000 and 1.000. The Mw₂ is constrained between 2,500 and 2,000,000. The “GRG Nonlinear” engine was selected in Excel Solver™ and precision was set at 0.00001 and convergence was set at 0.0001. The solutions were obtained after convergence (in all cases shown, the solution converged within 60 iterations).

End of absolute GPC test method.

### Conventional Gel Permeation Chromatography Test Method

The conventional GPC test method is for measuring molecular weights using a concentration-based detector. Use a PolymerChar GPC-IR (Valencia, Spain) high temperature GPC chromatograph equipped with an internal IR5 infra-red detector (IR5, measurement channel). Set temperatures of the autosampler oven compartment at 160° C. and column compartment at 150° C. Use a column set of four Agilent “Mixed A” 30 cm 20-micron linear mixed-bed columns; solvent is 1,2,4 trichlorobenzene (TCB) that contains 200 ppm of butylated hydroxytoluene (BHT) sparged with nitrogen. Injection volume is 200 microliters. Set flow rate to 1.0 milliliter/minute. Calibrate the column set with 21 narrow molecular weight distribution polystyrene (PS) standards (Agilent Technologies) with molecular weights ranging from 580 to 8,400,000. The PS standards were arranged in six “cocktail” mixtures with approximately a decade of separation between individual molecular weights in each vial. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. Convert the PS standard peak molecular weights (“MPS”) to polyethylene molecular weights (“MPE”) using the method described in Williams and Ward, J. Polym. Sci., Polym. Let., 6, 621 (1968) and equation 1 conventional (“(conv)”):

(M_{polyethylene}=A×(M_{polystyrene})B EQ. 1 (conv)
wherein M_{polyethylene} is molecular weight of polyethylene, M_{polystyrene} is molecular weight of polystyrene, A=0.413, x indicates multiplication, and B=1.0. Dissolve samples at 2 mg/mL in TCB solvent at 160° C. for 2 hours under low-speed shaking. Generate a baseline-subtracted infra-red (IR) chromatogram at each equally-spaced data collection point (i), and obtain polyethylene equivalent molecular weight from a narrow standard calibration curve for each point (i) from EQ. 1 conv.

Calculate number-average molecular weight (Mₙ or Mₙ_{^{(GPC)}}), weight-average molecular weight (M_{w} or M_{w}_{^{(GPC)}}), and z-average molecular weight (M_{z} or M_{z}_{^{(GPC)}}) based on GPC results using the internal IR5 detector (measurement channel) with PolymerChar GPCOne™ software and equations 2 (conv) to 4 (conv), respectively, the baseline-subtracted IR chromatogram at each equally-spaced data collection point (i), and the polyethylene equivalent molecular weight obtained from the narrow standard calibration curve for the point (i) from Equation 1 (conv).

$${Mn}_{( GPC )} = \frac{{\sum }^{i} {IR}_{i}}{{\sum }^{i} ( {IR}_{i} / {M}_{{polystyrene}_{i}} )} \qquad EQ . 2 ( conv )$$

$${Mw}_{( GPC )} = \frac{{\sum }^{i} ( {IR}_{i} * {M}_{{polystyrene}_{i}} )}{{\sum }^{i} {IR}_{i}} \qquad EQ . 3 ( conv )$$

$${Mz}_{( GPC )} = \frac{{\sum }^{i} ( {IR}_{i} * {{M}_{{polystyrene}_{i}}}^{2} )}{{\sum }^{i} ( {IR}_{i} * {M}_{{polystyrene}_{i}} )} \qquad EQ . 4 ( conv )$$

Monitor effective flow rate over time using decane as a nominal flow rate marker during sample runs. Look for deviations from the nominal decane flow rate obtained during narrow standards calibration runs. If necessary, adjust the effective flow rate of decane so as to stay within ±0.5% of the nominal flow rate of decane as calculated according to equation 5 (conv):

Flow rate(effective)=Flow rate(nominal)*(RV_{(FM Calculated})/RV_{(FM Sample)} (EQ. 5 (conv)),
wherein Flow rate(effective) is the effective flow rate of decane, Flowrate(nominal) is the nominal flow rate of decane, RV_{(FM Calibrated)} is retention volume of flow rate marker decane calculated for column calibration run using narrow standards, RV_{(FM Sample)} is retention volume of flow rate marker decane calculated from sample run, * indicates mathematical multiplication, and/indicates mathematical division. Discard any molecular weight data from a sample run with a decane flow rate deviation more than ±0.5%.

End of conventional GPC test method.

High Load Melt Index (HLMI) 121 Test Method: use ASTM D1238-13, Standard Test Method for Melt Flow Rates of Thermoplastics by Extrusion Platometer, using conditions of 190° C./21.6 kilograms (kg). Report results in units of grams eluted per 10 minutes (g/10 min.).

Hydrostatic Pipe Strength Test Method: measures hydrostatic pipe strength tested according to ISO 1162-2 at two different sets of temperature/pressure conditions comprising (i) 110° C./2.83 MPa; and (ii) 95° C./4.38 MPa).

Melt Index (“I₂”) Test Method: for ethylene-based (co)polymer is measured according to ASTM D1238-13, using conditions of 190° C./2.16 kg, formerly known as “Condition E”.

Melt Index I₅ (“I₅”) Test Method: use ASTM D1238-13, using conditions of 190° C./5.0 kg. Report results in units of grams eluted per 10 minutes (g/10 min.).

Melt Flow Ratio MFR2: (“I₂₁/I₂”) Test Method: calculated by dividing the value from the HLMI I₂₁ Test Method by the value from the Melt Index 12 Test Method.

Melt Flow Ratio MFR5: (“I₂₁/I₅”) Test Method: calculated by dividing the value from the HLMI I₂₁ Test Method by the value from the Melt Index 15 Test Method.

Slow Crack Growth (SCG) Resistance determined by Pennsylvania Edge Notch Tensile (“PENT”) Test Method: measures slow crack growth resistance according to ASTM F1473 at 80° C. and 2.4 MPa.

### EXAMPLES

Bimodal Catalyst System: a formulation of the PRODIGY™ BMC-200 described earlier having a 3.0:1.0 molar ratio of moles of Zr atoms of the bis((alkyl-substituted phenylamido)ethyl)amine ZrR₂ is of formula (II):

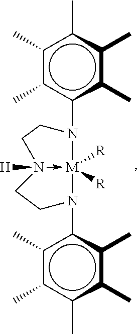

wherein each R is benzyl to moles of Zr atoms of the metal-ligand complex of formula (I) is redrawn below:

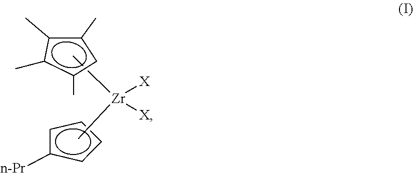

wherein n-Pr is —CH₂CH₂CH₃, and each X is CI or methyl. This metallocene catalyst is named herein (n-propylcyclopentadienyl)(tetramethylcyclopentadienyl)zirconium X₂.

Comonomer: 1-akene that is 1-hexene, which is a compound of formula H₂C═C(H)(CH₂)₃CH₃.

Continuity Additive 1: mixture of aluminum distearate and an ethoxylated amine type compound.” [0107] of US 2017/0081432 A1.

ICA: a mixture consisting essentially of at least 95%, alternatively at least 98% of 2-methylbutane (isopentane) and minor constituents that at least include pentane (CH₃(CH₂)₃CH₃). May be added to the gas phase polymerization reactor to enable condensing mode operation thereof.

Hydrogen gas: a molecular gas of formula H₂. May be added to the gas phase polymerization reactor to alter molecular weight of the polyethylene produced therein.

Mineral oil: Sonneborn HYDROBRITE 380 PO White. May be used as a carrier liquid for feeding catalyst into a gas phase polymerization reactor.

Monomer: ethylene (“C₂”), which is a compound of formula H₂C═CH₂.

Trim Catalyst Solution 1 (“TCS1”) comprising a solution of 0.04 wt % (propylcyclopentadienyl)(tetramethycyclopentadienyl)zirconium dimethyl in 99.96 wt % solvent comprising n-hexane and isopentane.

Polymerization Procedure. For Inventive Example 1 and Comparative Example 1 described below, copolymerized ethylene and 1-hexene using PRODIGY™ BMC-200 Catalyst System from Univation Technologies, LLC, and a controlled relative amount of the Trim Catalyst Solution 1 (TCS1) in a fluidized bed-gas phase polymerization (FB-GPP) reactor having a distribution grid to make an embodiment of the single reactor-made bimodal HDPE copolymer. The FB-GPP reactor had a 0.35 meter (m) internal diameter and 2.3 m bed height and a fluidized bed composed of polymer granules. Flowed fluidization gas through a recycle gas loop comprising sequentially a recycle gas compressor and a shell-and-tube heat exchanger having a water side and a gas side. The fluidization gas flows through the compressor, then the gas side of the shell-and-tube heat exchanger, then into the FB-GPP reactor below the distribution grid. Fluidization gas velocity in the reactor is about 0.52 to 0.55 meter per second (m/s, 1.7 to 1.8 feet per second). The fluidization gas then exits the FB-GPP reactor through a nozzle in the top of the reactor, and is recirculated continuously through the recycle gas loop. Maintained a constant fluidized bed temperature of 95° C. by continuously adjusting the temperature of the water on the shell side of the shell-and-tube heat exchanger. Introduced feed streams of ethylene, nitrogen, and hydrogen together with the 1-hexene comonomer into the recycle gas line. Operated the FB-GPP reactor at a total pressure of about 2414 kPa gauge, and vented reactor gases to a flare to control the total pressure. Adjusted individual flow rates of ethylene, nitrogen, hydrogen and the 1-hexene to maintain their respective gas composition targets. Set ethylene partial pressure to 1520 kilopascal (kPa, 219.8 pounds per square inch (psi)), and set the C₆/C₂ molar ratio and the H₂/C₂ molar ratio to the values reported in TABLE 1 below. Maintained isopentane (ICA) concentration at about 12.4 mol %, with the exact mol % values reported in TABLE 1. Average copolymer residence time was 2.0 to 2.2 hours. Measured concentrations of all gasses using an on-line gas chromatograph. Maintained the fluidized bed at constant height by withdrawing a portion of the bed at a rate equal to the rate of formation of particulate product that is the single reactor-made bimodal high-density poly(ethylene-co-1-hexene) copolymer. Product was removed semi-continuously via a series of valves into a fixed volume chamber. A nitrogen purge removed a significant portion of entrained and dissolved hydrocarbons in the fixed volume chamber. After purging, the product was discharged from the fixed volume chamber into a fiber pack for collection. The product was further treated with a small stream of humidified nitrogen to deactivate any trace quantities of residual catalyst and cocatalyst. Set the ratio feed of trim catalyst solution TCS1 to the feed of the bimodal catalyst system PRODIGY™ BMC-200 to adjust the HLMI (I₂₁) of the produced single reactor-made bimodal high-density poly(ethylene-co-1-hexene) copolymer in the reactor to I₂₁ approximately 17 g/10 min for CE1 and I₂₁ approximately 10 g/10 min. for IE1. Set the catalyst feeds at rates sufficient to maintain a production rate of about 19 to about 22 kg/hour (about 42 to about 48 lbs/hr) of the single reactor-made bimodal high-density poly(ethylene-co-e-hexene) copolymer.

Comparative Example 1 (CE1): CE1 is the Inventive Example 1 (“IE1”) of U.S. Pat. No. 11,149,136 B2 The copolymer of CE1 was made as described in U.S. Pat. No. 11,149,136 B2 using PRODIGY BMC-200 catalyst system obtained from Univation Technologies, LLC, Houston, Texas, USA. The polymerization conditions and process results are described in TABLE 1 below and the resin properties of CE1 are reported in TABLE 2 below.

Inventive Examples 1 and 2 (IE1 and IE2): synthesized embodiments of the inventive single reactor-made bimodal HOPE copolymer using the polymerization conditions described in TABLE 1 below and bimodal catalyst system product, PRODIGY™ BMC-200 catalyst system obtained from Univation Technologies, LLC, Houston, Texas, USA. The polymerization conditions and process results are described in TABLE 1 below and the resins' properties are described in TABLE 2 below.

TABLE 1:
Polymerization Conditions of IE1 and IE2.

| Polymerization Conditions | IE1 | IE2 |
|---|---|---|
| Monomer | ethylene | ethylene |
| Comonomer | 1-hexene | 1-hexene |
| Bimodal Catalyst System | PRODIGY ™ | PRODIGY ™ |
| | BMC-200 | BMC-200 |
| Trim Catalyst Solution (0.04 wt % TCS1) | TCS1 | TCS1 |
| TCS1/PRODIGY ™ BMC-200 mass flow ratio | 12.8 | 13.0 |
| Continuity Additive 1 (ppm) | 33 | 38 |
| Reactor type | Single FB-GPP | Single FB-GPP |
| Starting seedbed = fluidized granular HDPE resin | Preloaded | Preloaded |
| Bed weight (kg) | 42 | 42 |
| Bed Temperature (°C) | 95 | 95 |
| Ethylene (“C₂”) Partial Pressure (kPa) | 1520 | 1520 |
| 1-hexene/ethylene (“C₆/C₂”) Molar Ratio | 0.0073 | 0.0078 |
| H₂/C₂ Molar Ratio | 0.0026 | 0.0033 |
| Induced Condensing Agent 1-methylbutane (mol %) | 12.43 | 12.36 |
| Superficial Gas Velocity (m/sec) | 0.55 | 0.52 |
| Copolymer Production Rate (kg/hour) | 21.7 | 19.1 |
| Copolymer Residence Time (hour) | 2.0 | 2.2 |

As shown in TABLE 1, the bimodal catalyst system PRODIGY™ BMC-200 and trim catalyst solution TCS1 have been used under controlled gas phase polymerization process conditions to make a single reactor-made bimodal high-density poly(ethylene-co-1-hexene) copolymer having the improved properties shown below in TABLE 2. Varying the TCS1/BMC-200 mass flow ratio can be used to change the copolymer's I₂₁ property. Varying the H₂/C₂ Molar Ratio can be used to change the copolymer's molecular weight.

In TABLE 2, the Location of Log(MW) minima between Peaks of HMW and LMW Components (GPC_{(abs)}) Ratio HMW Component Peak Height/minima (GPC_{(abs)}), and Ratio LMW Component Peak Height/minima (GPC_{(abs)}) were determined according to the method described earlier in the paragraph subtitled Mathematical definition of absolute GPC molecular weight distribution properties.

TABLE 2:
Properties of the copolymers of CE1, IE1, and IE2 (properties of the “Copolymer”
are of the overall composition of matter, not an individual HMW or LMW component).

| Overall Formulation Property | CE1 | IE1 | IE2 |
|---|---|---|---|
| Source | Example 1 of | TABLE 1 | TABLE 1 |
| | US11149136B2 | | |
| Copolymer Monomer | Ethylene | Ethylene | Ethylene |
| Copolymer Comonomer | 1-Hexene | 1-Hexene | 1-hexene |
| Single FB-GPP Reactor Type? (yes or no) | Yes | Yes | Yes |
| Copolymer Modality of molecular weight | Bimodal | Bimodal | Bimodal |
| distribution | | | |
| Split HMW Component (wt %) (GPC_{(abs)}) | 57.8 | 49.2 | 51.9 |
| Split LMW Component (wt %) (GPC_{(abs)}) | 42.2 | 50.2 | 48.1 |
| Location of Log(MW) minima between Peaks of | 4.53 | 4.8 or 4.88? | 4.78 |
| HMW and LMW Components (GPC_{(abs)}) | | | |
| Ratio HMW Component Peak Height/minima | 1.9 | 1.5 | 1.7 |
| (GPC(abs)) | | | |
| Ratio LMW Component Peak Height/minima | 2.0 | 1.9 | 1.9 |
| (GPC_{(abs)}) | | | |
| Copolymer Density (g/cm³) | 0.9478 | 0.949 | 0.949 |
| Copolymer M_{z} (g/mol) (GPC_{(abs)}) (M_{z}(abs) | 1,083,620 | 1,084,180 | 960,030 |
| values) | | | |
| Copolymer M_{z} (g/mol) (GPC_{(abs)}) (M_{z}(BB) | 1,291,164 | 2,304,991 | 2,057,769 |
| values) | | | |
| Copolymer M_{w} (g/mol) (GPC_{(abs)}) | 190,156 | 230,729 | 217,283 |
| Copolymer Mₙ (g/mol) (GPC_{(abs)}) | 7,344 | 9,419 | 8,355 |
| Copolymer M_{w}/Mₙ (GPC_{(abs)}) | 25.9 | 24.5 | 26.0 |
| Copolymer M_{z}/M_{w} (GPC_{(abs)}) (based on | 5.70 | 4.70 | 4.42 |
| M_{z}(abs) values) | | | |
| Copolymer M_{z}/M_{w} (GPC_{(abs)}) (based on | 6.79 | 9.99 | 9.47 |
| M_{z}(BB) values) | | | |
| Copolymer I₂₁ (g/10 min.) | 17 | 9.8 | 10.05 |
| Copolymer I₅ (g/10 min.) | 0.85 | 0.28 | 0.33 |
| Copolymer I₂₁/I₅ | 21 | 35.0 | 30.4 |
| Copolymer I₂ (g/10 min.) | 0.24 | NMF | NMF |
| Copolymer I₂₁/I₂ | 71 | NMF | NMF |
| | | (>100) | (>100) |
| Copolymer SCG Resistance (PENT) (hours) | >2,000 | 7,210 | 7,969 |
| First Hydrostatic Pipe Strength (110 °C., 2.83 | N/m | 4,200 hours | 3,352 hours |
| MPa, ISO 22391-2 Eq. 3 is 7, GB\T 28799-1 | | | |
| 2020 Eq. B.3 is 41) | | | |
| Second Hydrostatic Pipe Strength (95 °C., 4.39 | N/m | Greater | Greater |
| MPa, ISO 22391-2 Eq. 3 is 0, GB\T 28799-1 | | than 1,400 | than 1,400 |
| 2020 Eq. B.3 is 1) | | hours | hours |
| Third Hydrostatic Pipe Strength (90 °C., 4.75 | 81.42 hours | 3,624 hours | 2,965 hours |
| MPa, ISO 22391-2 Eq. 3 is 0, GB\T 28799-1 | | | |
| 2020 Eq. B.3 is 3) | | | |

NMF for I₂ means not meaningful because the value is significantly below the minimum level of quantification of 0.15 g/10 min.; “NMF (>100)” for I₂₁/I₂ means not meaningful because the denominator value is not reliable, and based on estimated values for I₂ the I₂₁/I₂ value is expected to be greater than 100; the symbol > means greater than; N/m means not measured.

The examples of the inventive single reactor-made bimodal high-density poly(ethylene-co-1-hexene) copolymers of IE1 and IE2 independently have sufficient molecular architecture for achieving satisfactory melt rheology and processability of the resin in its melt (liquid) state in combination with sufficient chain entanglement of the polyethylene molecules of the resin in its solid state, including solid state in the form of a PE-RT Type II pipe. Although the Third Hydrostatic Pipe Strength (90° C., 4.75 MPa, ISO 22391-2 Eq. 3 is 0, GB\T 28799-1 2020 Eq. B.3 is 3) is useful for distinguishing IE1 and IE2 from CE1, the First Hydrostatic Pipe Strength (110° C., 2.83 MPa, ISO 22391-2 Eq. 3 is 7, GB\T 28799-1 2020 Eq. B.3 is 41) and/or Second Hydrostatic Pipe Strength (95° C., 4.39 MPa, ISO 22391-2 Eq. 3 is 0, GB\T 28799-1 2020 Eq. B.3 is 1) are preferred for characterizing the inventive single reactor-made bimodal HDPE copolymer and the inventive pipe comprising the single reactor-made bimodal HDPE copolymer.

1. A single reactor-made bimodal HDPE copolymer comprising from 45.0 weight percent (wt %) to 56.0 wt % of a higher molecular weight poly(ethylene-co-1-akene) copolymer component (HMW copolymer component) and from 55.0 wt % to 44.0 wt %, respectively, of a lower molecular weight poly(ethylene-co-1-akene) copolymer component (LMW copolymer component), wherein the wt % of the HMW copolymer component and the wt % of the LMW copolymer component are calculated as a percentage of their combined weight from absolute GPC measurements, and wherein the copolymer has each of properties (a) to (g):
(a) a density from 0.941 gram per cubic centimeter (g/cm³) to 0.957 g/cm³, measured according to ASTM D792-13 (Method B, 2-propanol);
(b) a melt index (I₅) from 0.20 to 0.40 grams per 10 minutes (g/10 min.), measured according to ASTM D1238-13 (190° C., 5.0 kg);
(c) a high load melt index (HLMI or I₂₁) from 9.0 to 11.0 grams per 10 minutes (g/10 min.), measured according to ASTM D1238-13 (190° C., 21.6 kg);
(d) a melt flow ratio (I₂₁/I₅) from 25 to 45;
(e) a polydispersity index (“PDI”), M_{z}/M_{w}, from 8.0 to 12.0, wherein M_{z} is z-average molecular weight based on M_{z}(BB) values and M_{w} is weight-average molecular weight, or M_{z}/M_{w}, from 3.5 to 5.2, alternatively from 4.0 to 5.0, wherein M_{z} is z-average molecular weight based on M_{z}(abs) values and M_{w} is as defined above, or both, as measured by absolute gel permeation chromatography;
(f) a slow crack growth (“SCG”) resistance of at least 5,000 hours, measured at 90° C. according to the Pennsylvania Edge Notch Tensile (“PENT”) Test Method;
(g) a first hydrostatic pipe strength of greater than 3,300 hours, measured according to ISO 1167-2 (110° C., 2.83 megapascals (MPa)), or a second hydrostatic pipe strength of greater than 1,400 hours, measured according to ISO 1167-2 (95° C., 4.39 MPa), or both.

2. The single reactor-made bimodal HDPE copolymer of claim 1, wherein the copolymer has at least one of the properties (a) to (g):
(a) the density is from 0.945 g/cm³ to 0.953 g/cm³, alternatively from 0.947 g/cm³ to 0.951 g/cm³, alternatively from 0.9485 g/cm³ to 0.9494 g/cm³;
(b) the melt index (I₅) is from 0.23 to 0.38 g/10 min., alternatively from 0.25 to 0.36 g/10 min., alternatively from 0.27 to 0.34 g/10 min.;
(c) the high load melt index (I₂₁) is from 9.2 to 10.6 g/10 min., alternatively from 9.4 to 10.4 g/10 min., alternatively from 9.6 to 10.2 g/10 min.;
(d) the melt flow ratio (I₂₁/I₅) is from 23 to 42, alternatively from 25 to 40, alternatively from 28 to 37;
(e) the polydispersity index (“PDI”), M_{z}/M_{w}, is from 8.5 to 11.4, alternatively from 8.9 to 10.9, preferably from 9.3 to 10.1, wherein M_{z} is based on M_{z}(BB) values; or M_{z}/M_{w}, is from 3.5 to 5.2 wherein M_{z} is z-average molecular weight based on M_{z}(abs) values and M_{w} is as defined above; or both;
(f) the slow crack growth (“SCG”) resistance (PENT) is at least 6,500 hours, alternatively at least 7,100 hours, alternatively at least 7,800 hours;
(g) the first hydrostatic pipe strength is either greater than 3,400 hours, alternatively greater than 3,500 hours, alternatively greater than 3,700 hours; or the second hydrostatic pipe strength is greater than 1,500 hours, alternatively greater than 1,600 hours, alternatively greater than 1,800 hours.

3. The single reactor-made bimodal HDPE copolymer of claim 1, wherein the wt % of the HMW component is from 47.0 to 54.0 wt %, alternatively from 47.6 to 52.4 wt %; and the wt % of the LMW component is from 53.0 to 46.0 wt %, alternatively from 52.4 to 47.6 wt %, respectively, wherein the foregoing wt % are calculated from absolute GPC measurements.

4. The single reactor-made bimodal HDPE copolymer of claim 1 selected from the group consisting of: a single reactor-made bimodal high-density poly(ethylene-co-1-butene) copolymer, a single reactor-made bimodal high-density poly(ethylene-co-1-hexene) copolymer, or a single reactor-made bimodal high-density poly(ethylene-co-1-octene) copolymer; or wherein the single reactor-made bimodal HDPE copolymer is a single reactor-made bimodal high-density poly(ethylene-co-1-hexene) copolymer.

5. The single reactor-made bimodal HDPE copolymer of claim 1, wherein the copolymer has a molecular weight selected from the group consisting of:
a weight-average molecular weight (M_{w}) from 200,001 grams per mole (g/mol) to 399,999 g/mol, measured by absolute gel permeation chromatography;
a number-average molecular weight (Mₙ) from 8,001 g/mol to 29,999 g/mol, measured by absolute gel permeation chromatography;
a z-average molecular weight (M_{z}) from 1,500,001 g/mol to 3,999,999 g/mol, based on M_{z}(BB) values measured by absolute gel permeation chromatography; and
a combination of any two or three of the molecular weights.

6. A method of making the single reactor-made bimodal HDPE copolymer of claim 1, the method comprising contacting ethylene and 1-akene with a bimodal catalyst system and a trim catalyst solution in a single gas phase polymerization (GPP) reactor to give the single reactor-made bimodal HDPE copolymer; wherein the bimodal catalyst system bimodal catalyst system comprises a metallocene catalyst, a post-metallocene catalyst, a solid support, and an activator.

7. The method of claim 6 wherein the metallocene catalyst comprises (n-propylcyclopentadienyl)(tetramethylcyclopentadienyl)zirconium X₂ of formula (I): 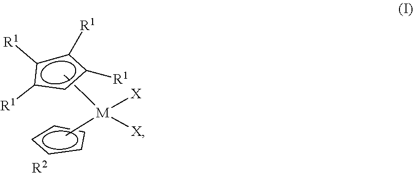
wherein each R¹ is methyl (—CH₃), R² is propyl (—CH₂CH₂CH₃), and each X is a leaving group; and wherein the post-metallocene catalyst comprises bis(2-(pentamethylphenylamido)ethyl)amine zirconium dibenzyl, which is a compound of formula (II) 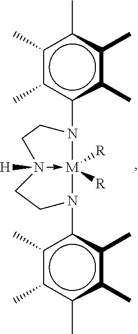
wherein M is Zr and each R is benzyl; and wherein the trim catalyst solution is an additional amount of the metallocene catalyst of formula (I) dissolved in an alkane.

8. A single reactor-made bimodal HDPE copolymer made by the method of claim 6.

9. A formulation comprising the single reactor-made bimodal HDPE copolymer of claim 1 and an additive.

10. A pipe comprising the single reactor-made bimodal HDPE copolymer of claim 1.

11. The pipe of claim 10 that meets standard specifications of ISO 22391 (2009) or standard specifications of GB/T 28799:2020, as described herein.
